(19) United States
(12) Patent Application Publication
(10) Pub. No.: US 2020/0005717 A1
(43) Pub. Date: Jan. 2, 2020

(54) DISPLAY DEVICE, VIRTUAL IMAGE DISPLAY DEVICE, AND METHOD FOR CONTROLLING DISPLAY DEVICE

(71) Applicant: SHARP KABUSHIKI KAISHA, Sakai City, Osaka (JP)

(72) Inventors: TAKESHI MASUDA, Sakai City, Osaka (JP); RYUZO YUKI, Sakai City, Osaka (JP); KEIICHI YAMAMOTO, Sakai City, Osaka (JP)

(21) Appl. No.: 16/490,698

(22) PCT Filed: Mar. 1, 2018
(86) PCT No.: PCT/JP2018/007875

§ 371 Date: Sep. 3, 2019

(30) Foreign Application Priority Data
Mar. 7, 2017 (JP) 2017-042808

(51) Int. Cl. G09G 3/34; G09G 3/36

(52) U.S. Cl. CPC G09G 3/3406; G09G 3/36; G09G 2310/08; G09G 2354/00; G09G 2320/0626; G09G 2320/02

(57) ABSTRACT

A blur (fuzziness) of an image is suppressed. A liquid crystal display device includes an LCD controller configured to write image data, a backlight configured to display an image, a visual line tracking unit configured to specify a position of a viewpoint, and a backlight controller configured to control a light emitting timing of the backlight. The backlight controller controls the light emitting timing of the backlight depending on the specified position of the viewpoint.

### TECHNICAL FIELD

The disclosure relates to a display device, particularly to a display device configured to display a moving picture, a virtual image display device, and a control method of the display device.

### BACKGROUND ART

In recent years, liquid crystal display (LCD) devices have been widely used. A liquid crystal display device is a display device that obtains a desired image signal by applying an electric field to a liquid crystal layer having a dielectric anisotropy, which is injected between two substrates, and adjusting strength of the electric field to adjust an amount of light passing through the substrates.

Further, in liquid crystal display devices, display data are scanned sequentially from a scanning line on an upper (or lower) part of a liquid crystal display panel to be written into liquid crystal pixels, and the display state is maintained when writing is finished. Therefore, the screen display is always rewritten sequentially from the upper (or lower) part to the lower (or upper) part of the screen. In a moving picture with fast motion, there is a possibility that an image in a previous field and an image in a subsequent field are recognized to overlap with each other. Due to this, in some cases, a user may view images in a frame-by-frame manner, or may view blurred images.

In view of this, PTL 1 describes a configuration in which display data is written into liquid crystal pixels for duration of two thirds of one field, backlight turns off, and the written display data is displayed with the backlight turned on for the remaining duration of one third of one field.

### CITATION LIST

### Patent Literature

PTL 1: JP 2000-293142 A (published on Oct. 20, 2000)

### SUMMARY

### Technical Problem

However, the related art described above has the following problem. In consideration of a response speed of the liquid crystal, there is a possibility that the backlight turns on before the liquid crystal completes the response in PTL 1. Description is given with reference to FIG. 10. FIG. 10 is a diagram illustrating a problem in the related art. As illustrated in FIG. 10, in PTL 1, in consideration of the liquid crystal response time, the lighting of the backlight and the liquid crystal response time in the lower region of the liquid crystal display panel overlap with each other for duration of the last one third of one field. Due to this, in the lower region of the liquid crystal display panel, the backlight turns on before the liquid crystal completes the response, and hence an incomplete image is displayed. A user recognizes this as a blur (fuzziness) of the image.

An aspect of the disclosure has been made in view of the above-mentioned problem, and has an object to achieve a display device and the like that suppress a blur (fuzziness) of an image.

### Solution to Problem

In order to achieve the above-mentioned object, a display device according to an aspect of the disclosure includes: a writing unit configured to write image data to a display panel while scanning the display panel; a light emitting portion configured to emit light and display an image on the display panel, the image being indicated by the image data being written; a viewpoint position specification unit configured to specify a position of a viewpoint of a user on the display panel; and a light emitting controller configured to control a light emitting timing of the light emitting portion, wherein the light emitting controller controls the light emitting timing of the light emitting portion depending on the position of the viewpoint being specified by the viewpoint position specification unit.

In order to achieve the above-mentioned object, a control method of a display device according to an aspect of the disclosure is a control method of the display device including a display panel and an light emitting portion configured to emit light and cause an image to be displayed on the display panel, the image being indicated by image data being written, the control method including: specifying a position of a viewpoint of a user on the display panel; writing image data to the display panel while scanning the display panel; and controlling a light emitting timing of the light emitting portion, wherein, in controlling the light emitting timing, the light emitting timing of the light emitting portion is controlled depending on the position of the viewpoint being specified in specifying the position of the viewpoint of the user.

### Advantageous Effects of Disclosure

According to an aspect of the disclosure, the light emitting timing of the light emitting portion is controlled depending on a position of a viewpoint of a user, and hence the light emitting portion can be caused to emit light at the viewpoint of the user after the image data is written. Thus, there can be exerted an effect of preventing a user from recognizing a blur (fuzziness) of an image, which is caused by the light emitting portion that emits light before the completion of the writing of the image data.

### BRIEF DESCRIPTION OF DRAWINGS

FIG. 1 is a block diagram illustrating a configuration of main portions of a liquid crystal display device according to the present embodiment.

FIG. 2 is a diagram illustrating processing of timing control for starting lighting of backlight, which is performed by a backlight controller.

FIG. 3 is a diagram illustrating the processing of the timing control for starting the lighting of the backlight, which is performed by the backlight controller.

FIG. 4 is a diagram illustrating the processing of the timing control for starting the lighting of the backlight, which is performed by the backlight controller.

FIG. 5 is a diagram illustrating the processing of the timing control for starting the lighting of the backlight, which is performed by the backlight controller.

FIG. 6 is a diagram illustrating the processing of the timing control for starting the lighting of the backlight, which is performed by the backlight controller.

FIG. 7 is a diagram illustrating an example of a table used by the backlight controller for controlling lighting timing of the backlight.

FIG. 8 is a diagram illustrating processing of the backlight controller in a case where a viewpoint of a user moves.

FIG. 9 is a block diagram illustrating a configuration of main portions of a virtual image display device.

FIG. 10 is a diagram illustrating a problem in the related art.

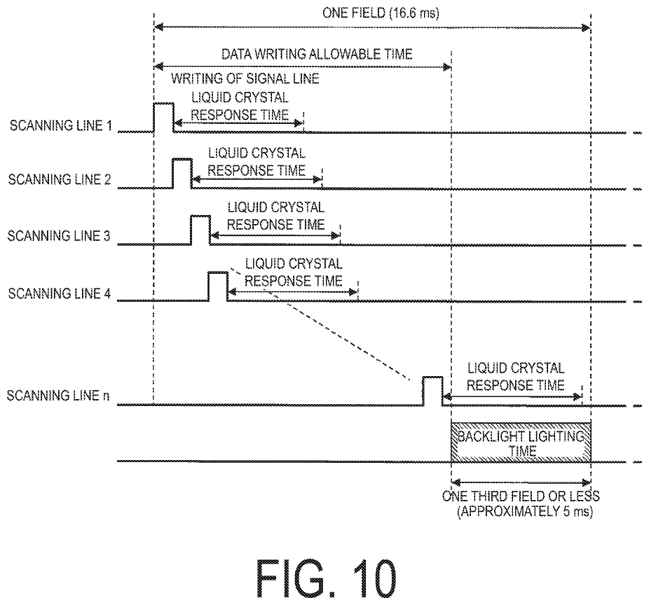

### DESCRIPTION OF EMBODIMENTS

### First Embodiment

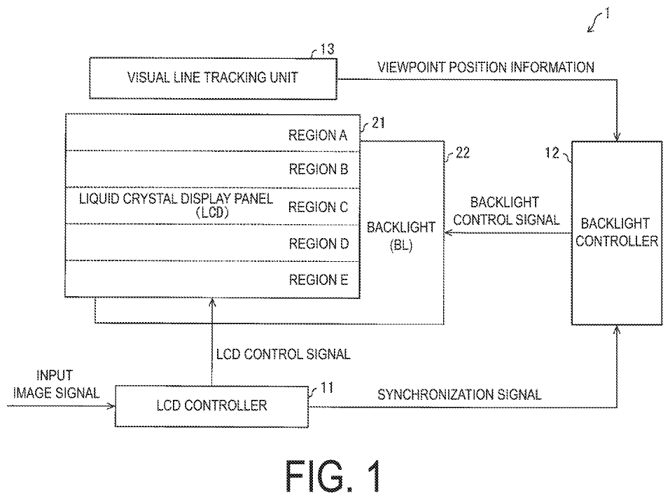

Now, with reference to FIG. 1 to FIG. 8, detailed description of embodiments of the disclosure will be provided. FIG. 1 is a block diagram illustrating a configuration of main portions of a liquid crystal display device (display device) 1 according to the present embodiment. As illustrated in FIG. 1, the liquid crystal display device 1 according to the disclosure includes a liquid crystal display panel (LCD) 21, a backlight (BL) 22, an LCD controller (writing unit) 11, a backlight controller (light emitting controller) 12, and a visual line tracking unit (viewpoint position specification unit) 13.

The liquid crystal display panel (display panel) 21 is a display panel including a liquid crystal layer between substrates, which receives an LCD control signal (image data) from the LCD controller 11 described later, to thereby display an image.

The backlight (light emitting portion) 22 is provided on a back surface of the liquid crystal display panel 21, and emits light to the liquid crystal display panel 21.

The LCD controller 11 generates a drive signal (LCD control signal) for displaying an image on the liquid crystal display panel 21, based on the transmitted input image signal, and transmits the drive signal cyclically to the liquid crystal display panel 21. The LCD controller 11 transmits a synchronization signal to the backlight controller 12.

The backlight controller 12 transmits a backlight control signal to the backlight 22, based on the synchronization signal transmitted from the LCD controller 11 and viewpoint position information transmitted from the visual line tracking unit 13 described later, and controls timing for starting lighting of the backlight 22 (the light emitting timing) and a lighting period. Note that, details of the processing of the backlight controller 12 is described later.

The visual line tracking unit 13 specifies a direction of a visual line of a user, in other words, a position on the liquid crystal display panel 21 that the user views, and transmits the viewpoint position information indicating the specified position to the backlight controller 12. Note that, a method of specifying a direction of a visual line of a user is well-known, and hence the description thereof is omitted.

### Details of Backlight Controller 12

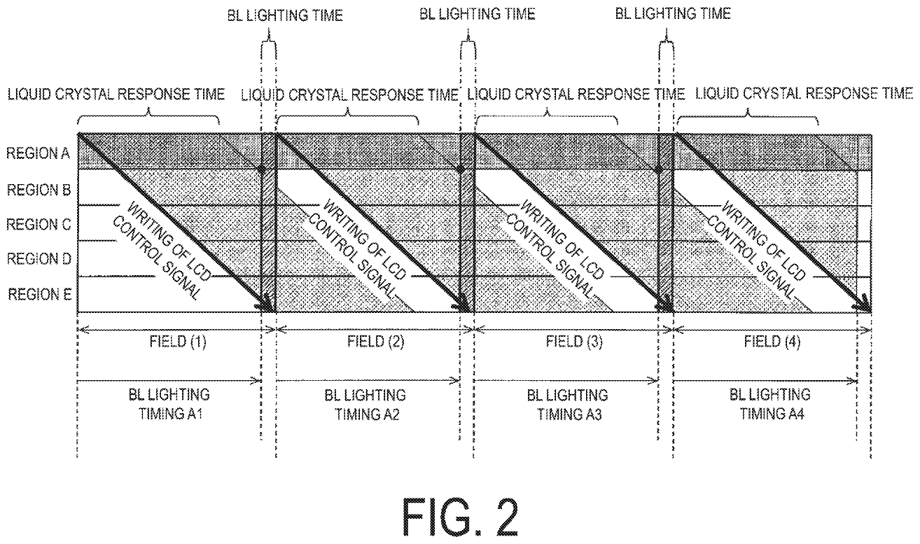

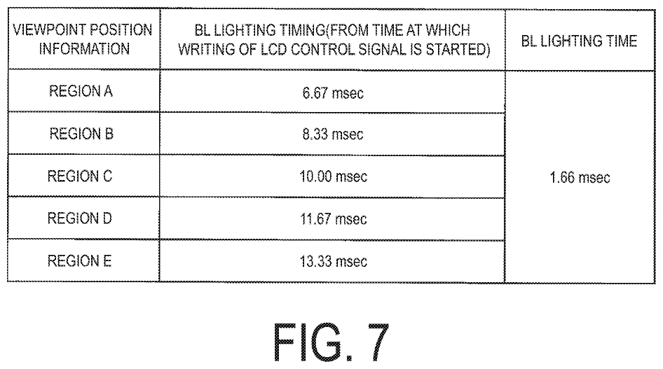

Next, with reference to FIG. 2 to FIG. 7, a detailed description of the processing of the backlight controller 12 will be provided. Each of FIG. 2 to FIG. 6 is a diagram illustrating the processing of the timing control for starting the lighting of the backlight 22, which is performed by the backlight controller 12. FIG. 7 is a diagram illustrating an example of a table used by the backlight controller 12 for controlling lighting timing of the backlight 22.

In the present embodiment, the liquid crystal display panel 21 is divided into five virtual regions including, from the upper part, a region A, a region B, a region C, a region D, and a region E to control the lighting timing of the backlight 22. Note that, the division of the liquid crystal display panel 21 into the virtual regions is not limited thereto, and the number of divided regions may be freely selected as long as the division is made in a scanning direction.

Through use of the viewpoint position information transmitted from the visual line tracking unit 13, the backlight controller 12 adjusts the lighting timing of the backlight 22 depending on a region in the liquid crystal display panel 21 in which a viewpoint of a user is positioned. More specifically, the backlight controller 12 adjusts the backlight 22 to turn on at a timing when a response time of the liquid crystal in the region in which the viewpoint of the user is positioned is completed.

First, with reference to FIG. 2, a description of a case where the viewpoint of the user is positioned in the region A is provided. As illustrated in FIG. 2, in the case where the viewpoint of the user is positioned in the region A, in field (1), the writing of the LCD control signal is performed in the region A, and the lighting of the backlight 22 is performed for a predetermined time at a timing when a liquid crystal response time elapses, that is, when a BL lighting timing (A1) elapses from the writing of the LCD control signal.

Similarly in field (2), the writing of the LCD control signal is performed in the region A, and the lighting of the backlight 22 is performed for the predetermined time at a timing when the liquid crystal response time elapses, that is, when a BL lighting timing (A2) elapses from the writing of the LCD control signal. After that, the same holds true in fields (3), (4), and the like.

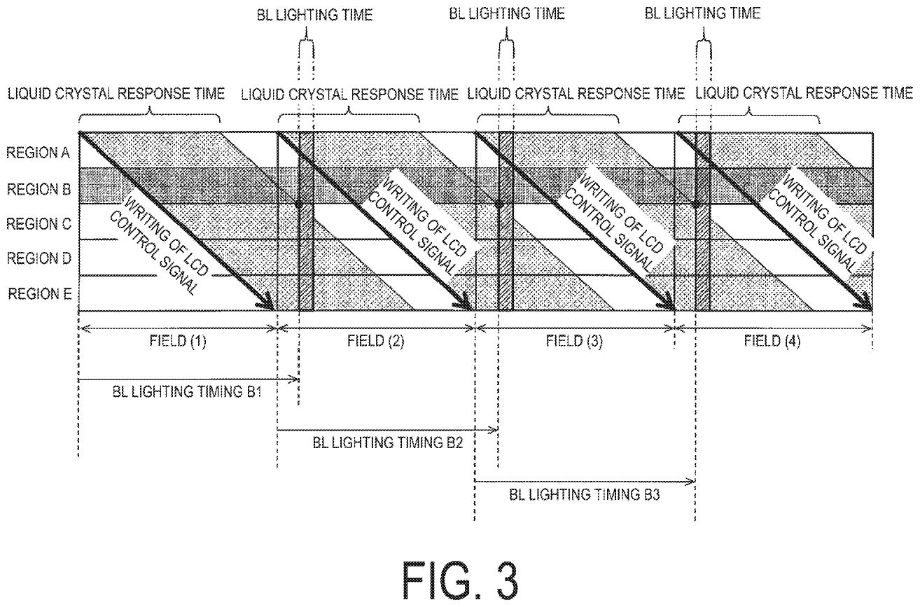

Next, with reference to FIG. 3, a description of a case where the viewpoint of the user is positioned in the region B will be provided. As illustrated in FIG. 3, in the case where the viewpoint of the user is positioned in the region B, in field (1), the writing of the LCD control signal is performed in the region B, and the lighting of the backlight 22 is performed for the predetermined time at a timing when the liquid crystal response time elapses, that is, when a BL lighting timing (B1) elapses from the writing of the LCD control signal.

Similarly in field (2), the writing of the LCD control signal is performed in the region B, and the lighting of the backlight 22 is performed for the predetermined time at a timing when the liquid crystal response time elapses, that is, when a BL lighting timing (B2) elapses from the writing of the LCD control signal. After that, the same applies fields (3), (4), and the like.

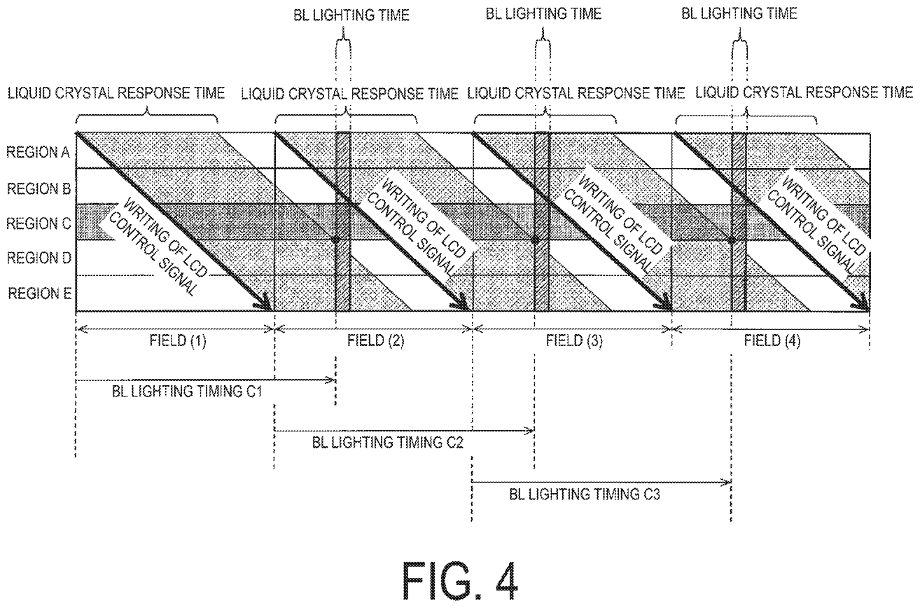

Next, with reference to FIG. 4, a description of a case where the viewpoint of the user is positioned in the region C will be provided. As illustrated in FIG. 4, in the case where the viewpoint of the user is positioned in the region C, in field (1), the writing of the LCD control signal is performed in the region C, and the lighting of the backlight 22 is performed for the predetermined time at a timing when the liquid crystal response time elapses, that is, when a BL lighting timing (C1) elapses from the writing of the LCD control signal.

Similarly in field (2), the writing of the LCD control signal is performed in the region C, and the lighting of the backlight 22 is performed for the predetermined time at a timing when the liquid crystal response time elapses, that is, when a BL lighting timing (C2) elapses from the writing of the LCD control signal. After that, the same applies fields (3), (4), and the like.

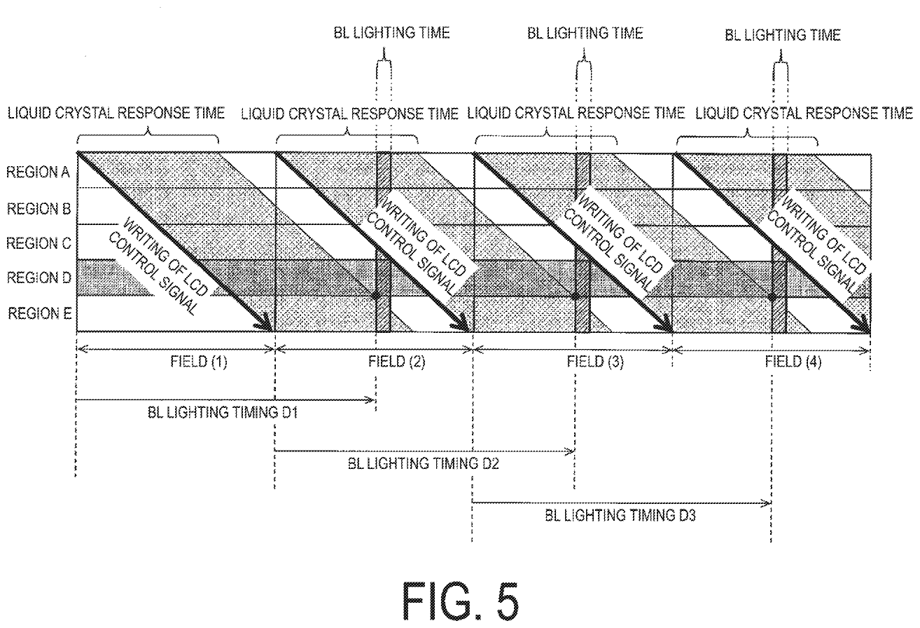

Next, with reference to FIG. 5, a description of a case where the viewpoint of the user is positioned in the region D will be provided. As illustrated in FIG. 5, in the case where the viewpoint of the user is positioned in the region D, in field (1), the writing of the LCD control signal is performed in the region D, and the lighting of the backlight 22 is performed for the predetermined time at a timing when the liquid crystal response time elapses, that is, when a BL lighting timing (D1) elapses from the writing of the LCD control signal.

Similarly in field (2), the writing of the LCD control signal is performed in the region D, and the lighting of the backlight 22 is performed for the predetermined time at a timing when the liquid crystal response time elapses, that is, when a BL lighting timing (D2) elapses from the writing of the LCD control signal. After that, the same applies fields (3), (4), and the like.

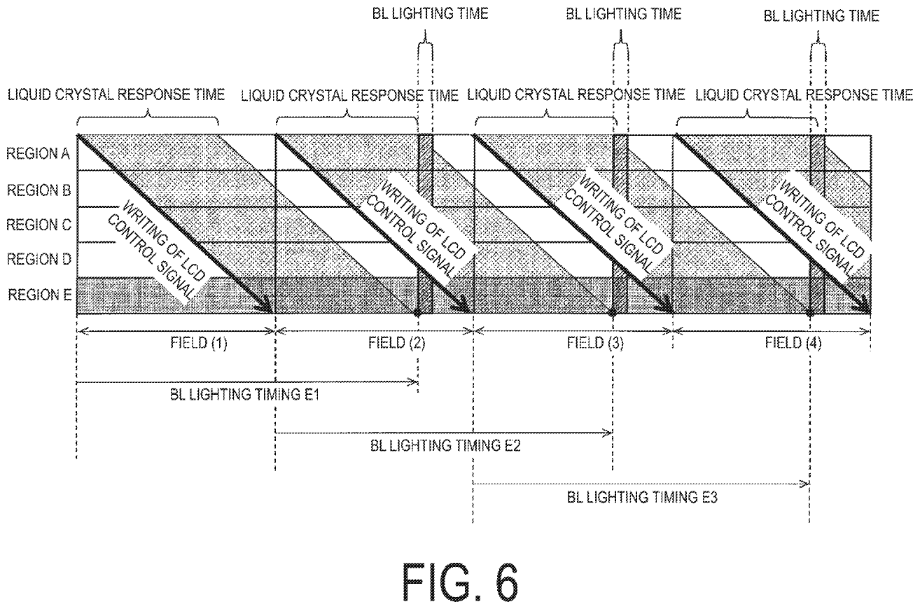

Next, with reference to FIG. 6, a description of a case where the viewpoint of the user is positioned in the region E will be provided. As illustrated in FIG. 6, in the case where the viewpoint of the user is positioned in the region E, in field (1), the writing of the LCD control signal is performed in the region E, and the lighting of the backlight 22 is performed for the predetermined time at a timing when the liquid crystal response time elapses, that is, when a BL lighting timing (E1) elapses from the writing of the LCD control signal.

Similarly in field (2), the writing of the LCD control signal is performed in the region E, and the lighting of the backlight 22 is performed for the predetermined time at a timing when the liquid crystal response time elapses, that is, when a BL lighting timing (E2) elapses from the writing of the LCD control signal. After that, the same applies fields (3), (4), and the like.

Next, with reference to FIG. 7, a description of a specific example of the control timing of the backlight controller 12 will be provided. FIG. 7 is a table in which the position of the viewpoint of the user, the lighting timing of the backlight 22, and the lighting time of the backlight 22 are associated with one another. Note that, in the example illustrated in FIG. 7, it is assumed that a writing frequency (field frequency) of the LCD control signal is 120 Hz (8.33 msec), and the liquid crystal response time is 5 msec.

As illustrated in FIG. 7, in the case where the position of the viewpoint of the user is in the region A, the lighting timing of the backlight 22 is 6.67 msec (millisecond) after the writing of the LCD control signal. That is, each of the above-mentioned BL lighting timings (A1, A2, . . . ) corresponds to 6.67 msec (millisecond). The backlight controller 12 causes the backlight 22 to turn on for 1.66 msec (millisecond). Note that, the lighting time of the backlight 22 is the same regardless of the position of the viewpoint of the user.

Due to this, the backlight 22 turns off for 6.67 msec (=8.33/5+5) after the writing of the LCD control signal is started, and turns on for next 1.66 msec.

As illustrated in FIG. 7, in the case where the position of the viewpoint of the user is in the region B, the lighting timing of the backlight 22 is 8.33 msec (millisecond) after the writing of the LCD control signal. That is, each of the above-mentioned BL lighting timings (B1, B2, . . . ) corresponds to 8.33 msec (millisecond).

Due to this, the backlight 22 turns off for 8.33 msec (=8.33/5×2+5) after the writing of the LCD control signal is started, and turns on for next 1.66 msec.

In the case where the position of the viewpoint of the user is in the region C, the lighting timing of the backlight 22 is 10.00 msec (millisecond) after the writing of the LCD control signal. That is, each of the above-mentioned BL lighting timings (C1, C2, . . . ) corresponds to 10.00 msec (millisecond).

Due to this, the backlight 22 turns off for 10.00 msec (=8.33/5×3+5) after the writing of the LCD control signal is started, and turns on for next 1.66 msec.

In the case where the position of the viewpoint of the user is in the region D, the lighting timing of the backlight 22 is 11.67 msec (millisecond) after the writing of the LCD control signal. That is, each of the above-mentioned BL lighting timings (D1, D2, . . . ) corresponds to 11.67 msec (millisecond).

Due to this, the backlight 22 turns off for 11.67 msec (=8.33/5×4+5) after the writing of the LCD control signal is started, and turns on for next 1.66 msec.

In the case where the position of the viewpoint of the user is in the region E, the lighting timing of the backlight 22 is 13.33 msec (millisecond) after the writing of the LCD control signal. That is, each of the above-mentioned BL lighting timings (E1, E2, . . . ) corresponds to 13.33 msec (millisecond).

Due to this, the backlight 22 turns off for 13.33 msec (=8.33/5×5+5) after the writing of the LCD control signal is started, and turns on for next 1.66 msec.

Note that, the lighting timings of the backlight 22 and the lighting times that are described above are merely examples, and may be set as appropriate depending on the number of set virtual regions, the writing frequency of the LCD control signal, and the liquid crystal response time.

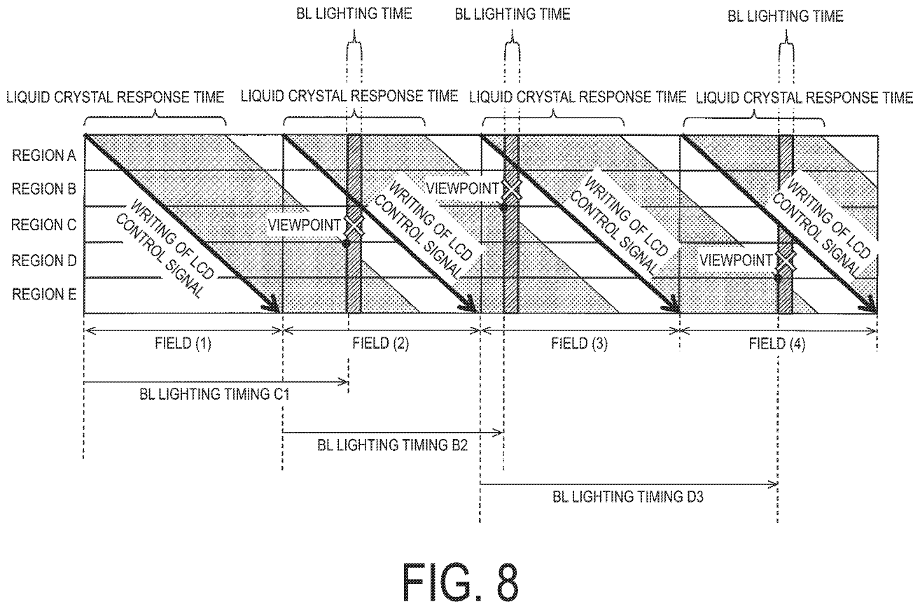

Note that, the position of the viewpoint of the user is not always in the same region. Thus, with reference to FIG. 8, a description of the processing of the backlight controller 12 in a case where the position of the viewpoint of the user moves is provided. FIG. 8 is a diagram illustrating the processing of the backlight controller 12 in the case where the viewpoint of the user moves. In the example illustrated in FIG. 8, the viewpoint of the user is in the region C in field (1), the viewpoint of the user is in the region B in field (2), and the viewpoint of the user is in the region D in field (3).

As illustrated in FIG. 8, in a case where the viewpoint of the user is in the region C during field (1), the writing of the LCD control signal is performed in the region C, and the lighting of the backlight 22 is performed for the predetermined time at a timing when the liquid crystal response time elapses, that is, when the BL lighting timing (C1) elapses from the writing of the LCD control signal in field (1).

Further, in a case where the viewpoint of the user moves to the region B during field (2), the writing of the LCD control signal is performed in the region B, and the lighting of the backlight 22 is performed for the predetermined time at a timing when the liquid crystal response time elapses, that is, when the BL lighting timing (B2) elapses from the writing of the LCD control signal in field (2).

Further, in a case where the viewpoint of the user moves to the region D during field (3), the writing of the LCD control signal is performed in the region D, and the lighting of the backlight 22 is performed for the predetermined time at a timing when the liquid crystal response time elapses, that is, when the BL lighting timing (D3) elapses from the writing of the LCD control signal in field (3).

As described above, in the present embodiment, in a direction of the visual line of the user, that is, at a position on the liquid crystal display panel 21 that the user views, the backlight 22 turns on in a case where the response time of the liquid crystal elapses. Thus, in the region that the user views, the backlight 22 does not turn on unless the liquid crystal response time elapses. Therefore, the user can be prevented from recognizing a blur (fuzziness) of an image, which is caused by the lighting of the backlight 22 before the liquid crystal response time elapses.

### Second Embodiment

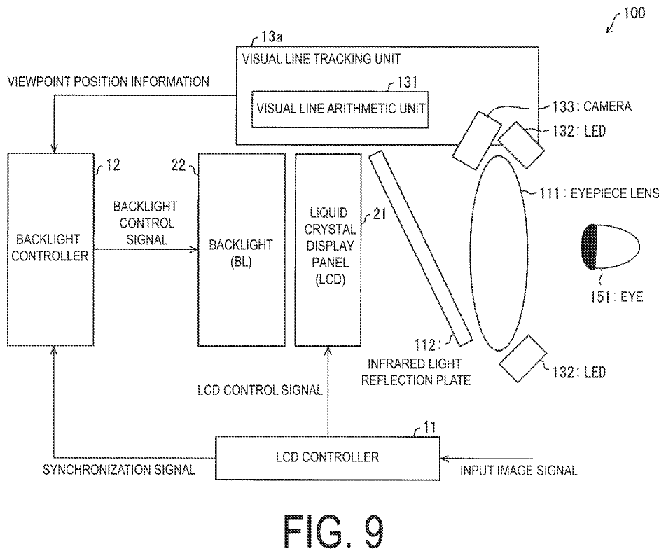

With reference to FIG. 9, a description of another embodiment of the disclosure will be provided below. Note that, for convenience of description, members having the same function as the members stated in the embodiment above are designated by the same reference signs, and the description thereof is omitted. In the present embodiment, the processes of lighting the backlight in the first embodiment described above is applied to a virtual image display device (display device) 100 such as a Head Mount Display (HMD). For example, the HMD can be worn on the head of the user, and can provide a virtual space to the user.

First, with reference to FIG. 9, a description of the configuration of the virtual image display device 100 will be provided. FIG. 9 is a block diagram illustrating a configuration of main portions of the virtual image display device 100. As illustrated in FIG. 9, the virtual image display device 100 according to the present embodiment includes the liquid crystal display panel 21, the backlight 22, the LCD controller 11, the backlight controller 12, a visual line tracking unit 13a, an eyepiece lens 111, and an infrared light reflection plate 112.

The visual line tracking unit 13a specifies the direction of the visual line of the user, in other words, the position on the liquid crystal display panel 21 that the user views. Specifically, the visual line tracking unit 13a includes a visual line arithmetic unit 131, an LED 132, and a camera 133.

The visual line arithmetic unit 131 specifies the direction of the visual line of the user from a captured image of infrared light. The LED 132 is an LED that emits infrared light, and is arranged to emit the light in a direction to an eye 151 of the user. The camera 133 is an infrared light camera capable of imaging infrared light, and is arranged to capture an image with infrared light reflected by the infrared light reflection plate 112. Further, the infrared light emitted from the LED 132 in the direction to the eye 151 of the user is reflected by the eye 151, passes through the eyepiece lens 111, is further reflected by the infrared light reflection plate 112, and advances in the direction to the camera 133. The camera 133 captures an image with infrared light, and transmits the captured image to the visual line arithmetic unit 131. The visual line arithmetic unit 131 specifies the direction of the visual line from the captured image obtained by the camera 133.

The eyepiece lens 111 receives an image to be displayed on the liquid crystal display panel 21, and projects an enlarged image (virtual image) to the eye 151 of the user. That is, the user views, through the eyepiece lens 111, the enlarged image of the image displayed on the liquid crystal display panel 21. As an example of the eyepiece lens 111, for example, a plastic convex lens having a diameter of 3 inch is given.

The infrared light reflection plate 112 selectively reflects infrared light, and causes visible light to pass therethrough. Due to this, a display image on the liquid crystal display panel 21 can pass through to be recognized by the user, and the infrared light emitted from the LED 132 can be reflected.

The LCD controller 11, the backlight controller 12, the liquid crystal display panel 21, and the backlight 22 are similar to those in the first embodiment described above. Note that, in the present embodiment, a 5 inch Full High Definition (FHD) may be used as the liquid crystal display panel 21, and an edge light type LED-BL having the same size as the liquid crystal display panel 21 may be used as the backlight 22.

Also in the present embodiment, similarly to the first embodiment, the backlight controller 12 transmits the backlight control signal to the backlight 22, based on the synchronization signal transmitted from the LCD controller 11 and the viewpoint position information transmitted from the visual line tracking unit 13a, and controls the timing for starting the lighting of the backlight 22 and the lighting period.

Due to this, in the direction of the visual line of the user, that is, at the position on the liquid crystal display panel 21 that the user views, the backlight 22 can turn on in a case where the response time of the liquid crystal elapses. Thus, in the region that the user views, the backlight 22 does not turn on unless the liquid crystal response time elapses. Therefore, the user can be prevented from recognizing a blur (fuzziness) of an image, which is caused by the lighting of the backlight 22 before the liquid crystal response time elapses.

### Third Embodiment

In the first and second embodiments described above, a description of the examples in which the liquid crystal display panel 21 is used, is provided. However, the disclosure is not limited to the liquid crystal display panel 21, but may be applied to any display device as long as the display device displays an image with a light emitting portion such as a backlight that emits light, based on a control signal being input cyclically.

The display device described above can prevent a user from recognizing a blur (fuzziness) of an image by dividing a display portion into a plurality of virtual regions, specifying a position of a viewpoint of a user, and causing a light emitting portion to emit light in a region containing the position of the viewpoint of the user at a timing when an image based on a control signal that is input cyclically is displayed appropriately.

### Supplement

A display device according to a first aspect of the disclosure includes: a writing unit configured to write image data to a display panel while scanning the display panel; a light emitting portion configured to emit light and display an image on the display panel, the image being indicated by the image data being written; a viewpoint position specification unit configured to specify a position of a viewpoint of a user on the display panel; and a light emitting controller configured to control a light emitting timing of the light emitting portion, wherein the light emitting controller controls the light emitting timing of the light emitting portion depending on the position of the viewpoint being specified by the viewpoint position specification unit.

According to the above-mentioned configuration, the light emitting timing of the light emitting portion is controlled depending on the position of the viewpoint of the user, and hence the light emitting portion can be caused to emit light at the viewpoint of the user after the image data is written. Due to this, the user can be prevented from recognizing a blur (fuzziness) of an image, which is caused by the light emitting portion that emits light before the completion of the writing of the image data.

A display device according to a second aspect of the disclosure may be configured such that, in the first aspect described above, the writing unit performs writing of the image data at a cycle, the viewpoint position specification unit specifies the position of the viewpoint of the user on the display panel at the cycle, and the light emitting controller controls the light emitting timing of the light emitting portion depending on the position of the viewpoint being specified by the viewpoint position specification unit at the cycle.

According to the above-mentioned configuration, a position of a viewpoint is specified at a cycle in the image data written at the cycle, and a light emitting timing of the light emitting portion is controlled depending on the position of the viewpoint being specified. Thus, in a case of continuous images such as a moving picture, the user is always prevented from recognizing a blur (fuzziness) of the images.

A display device according to a third aspect of the disclosure may be configured such that, in the first or second aspect described above, the display panel is a liquid crystal display panel, and the light emitting controller causes the light emitting portion to emit light in a case where a liquid crystal response time of the liquid crystal display panel corresponding to the position of the viewpoint elapses from a time at which the image data is written.

According to the above-mentioned configuration, on the liquid crystal display panel, the light emitting portion is caused to emit light in a case where the liquid crystal response time on the liquid crystal display panel corresponding to the position of the viewpoint elapses, and hence, at the position of the viewpoint of the user, the light emitting portion can be caused to emit light at a timing when the written image data can be displayed appropriately. Due to this, the light can be emitted in consideration of the response time of the liquid crystal. The user can be prevented from recognizing a blur (fuzziness) of an image, which is caused by the light emitting portion that emits light before the completion of the writing of the image data.

A display device according to a fourth aspect of the disclosure may be configured such that, in the third aspect described above, the liquid crystal display panel is divided into a plurality of regions, and the light emitting controller causes the light emitting portion to emit light in a case where the liquid crystal response time in a region containing the position of the viewpoint among the plurality of regions elapses from a time at which the image data is written.

According to the above-mentioned configuration, the light emission can be controlled for each region containing the position of the viewpoint.

A virtual image display device according to a fifth aspect of the disclosure is a virtual image display device for providing a virtual space to a user, the virtual image display device including: the display device according to any one of first to fourth aspects described above; and an eyepiece lens arranged between the display panel of the display device and the user, and configured to provide the user with an image being displayed on the display panel in an enlarged manner.

According to the above-mentioned configuration, in the virtual image display device configured to provide the virtual space to the user, the user can be prevented from recognizing a blur (fuzziness) of an image.

A control method of a display device according to a sixth aspect of the disclosure is a control method of the display device including a display panel and an light emitting portion configured to emit light and cause an image to be displayed on the display panel, the image being indicated by image data being written, the control method including: specifying a position of a viewpoint of a user on the display panel; writing image data to the display panel while scanning the display panel; and controlling a light emitting timing of the light emitting portion, wherein, in controlling the light emitting timing, the light emitting timing of the light emitting portion is controlled depending on the position of the viewpoint being specified in specifying the position of the viewpoint of the user.

The disclosure is not limited to each of the embodiments described above, and various modifications may be made within the scope of the claims. Embodiments obtained by appropriately combining technical approaches disclosed in each of the different embodiments also fall within the technical scope of the disclosure. Moreover, novel technical features can be formed by combining the technical approaches disclosed in the embodiments.

### REFERENCE SIGNS LIST

1 Liquid crystal display device (display device)
11 LCD controller (writing unit)
12 Backlight controller (light emitting controller)
13, 13a Visual line tracking unit (viewpoint position specification unit)
21 Liquid crystal display panel (display panel)
22 Backlight (light emitting portion)
100 Virtual image display device (display device)
111 Eyepiece lens
112 Infrared light reflection plate
131 Visual line arithmetic unit
132 LED
133 Camera

1. A display device comprising:
a writing unit configured to write image data to a display panel while scanning the display panel;
a light emitting portion configured to emit light and display an image on the display panel, the image being indicated by the image data being written;
a viewpoint position specification unit configured to specify a position of a viewpoint of a user on the display panel; and
a light emitting controller configured to control a light emitting timing of the light emitting portion,
wherein the light emitting controller controls the light emitting timing of the light emitting portion depending on the position of the viewpoint being specified by the viewpoint position specification unit.

2. The display device according to claim 1,
wherein the writing unit performs writing of the image data at a cycle,
the viewpoint position specification unit specifies the position of the viewpoint of the user on the display panel at the cycle, and
the light emitting controller controls the light emitting timing of the light emitting portion depending on the position of the viewpoint being specified by the viewpoint position specification unit at the cycle.

3. The display device according to claim 1,
wherein the display panel is a liquid crystal display panel, and
the light emitting controller causes the light emitting portion to emit light in a case where a liquid crystal response time of the liquid crystal display panel corresponding to the position of the viewpoint elapses from a time at which the image data are written.

4. The display device according to claim 3,
wherein the display panel is divided into a plurality of regions, and
the light emitting controller causes the light emitting portion to emit light in a case where the liquid crystal response time in a region containing the position of the viewpoint among the plurality of regions elapses from a time at which the image data are written.

5. A virtual image display device for providing a virtual space to a user, the virtual image display device comprising:
the display device according to claim 1; and
an eyepiece lens arranged between the display panel of the display device and the user, and configured to provide the user with an image being displayed on the display panel in an enlarged manner.

6. A control method of a display device, the display device including a display panel and an light emitting portion configured to emit light and cause an image to be displayed on the display panel, the image being indicated by image data being written, the control method comprising:
specifying a position of a viewpoint of a user on the display panel;
writing image data to the display panel while scanning the display panel; and
controlling a light emitting timing of the light emitting portion,
wherein, in controlling the light emitting timing, the light emitting timing of the light emitting portion is controlled depending on the position of the viewpoint being specified in specifying the position of the viewpoint of the user.
